(19) United States
(12) Patent Application Publication
(10) Pub. No.: US 2009/0207174 A1
(43) Pub. Date: Aug. 20, 2009

(54) Computer Graphic Method and Modular Thereof

(75) Inventor: Ming-Song Chen, Chung Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AVERMEDIA INFORMATION, INC., Chung Ho City (TW)

(21) Appl. No.: 12/114,098

(22) Filed: May 2, 2008

(30) Foreign Application Priority Data
Feb. 15, 2008 (TW) 97105368

(51) Int. Cl. G09G 5/00

(52) U.S. Cl. 345/442; 345/441; 345/173; 345/163; 345/443

(57) ABSTRACT

Computer graphic method is used to transform a irregular hand drawing into a regular shape, such as a circuit, a rectangle, or a curve. First step of the computer graphic method is inputting the hand drawing to a computer. Then, identify at least one characteristic of the hand drawing, and creating a regular shape based on the characteristic. Finally, replacing the hand drawing with the regular shape.

### RELATED APPLICATIONS

This application claims priority to Taiwan Application Serial Number 97105368, filed Feb. 15, 2008, which is herein incorporated by reference.

### BACKGROUND

1. Field of Invention

The present invention relates to image data processing. More particularly, the present invention relates to computer graphics.

2. Description of Related Art

Today, computers may help us deal with almost all kinds of image data, such as drawings, photos, and animation. There is also plenty of software that can be used to make computer graphics more convenient, for example AutoCAD, Flash, Photoshop, and Illustrator etc.

However, no matter what computer graphic software is used, when a user wants to draw some regular shape, like a circle, a rectangle, or a straight line, he has to choose the corresponding graphic tool. For example, when the user wants to draw a rectangle and a circle, he may select a circle tool to create a circle and then select a rectangle tool to create a rectangle. The user has to use many tools to draw many different shapes in one picture. It's not convenient at all.

Therefore, a new method and software for computer graphics is needed, which may create many different shapes without changing many tools.

### SUMMARY

A method for computer graphics is provided. The computer graphic method may convert a hand drawing drawn by a user into a regular shape, like a circuit, an ellipse, a rectangle, a polygon, a straight line, or a curve.

The computer graphic method has four steps. First, inputting a hand drawing to a computer. Then, identifying the characteristic of the hand drawing. Next a regular shape is created based on the hand drawn image characteristics. Finally, replacing the hand drawing with the regular shape.

Therefore, the user doesn't need to select as many tools, and only has to draw a hand drawing similar to a regular shape. The hand drawing will then be converted into the regular shape.

Another method for computer graphics for transforming a hand drawing into a regular shape is provided. To do this the following steps must be followed: draw a hand drawing in a computer using an input device; identify at least a characteristic of the hand drawing; compare the characteristics with a plurality of regular characteristics; create a regular shape base on comparative results; replace the hand drawing with the regular shape. By using the computer graphic method of the embodiment of this invention, drawing many different shapes can be drawn in a picture without needing to select many different tools.

In addition, the invention also discloses a computer graphics module, which may produce a regular shape according to a user hand drawing. The computer graphics module includes a calculation unit, a comparison unit, and a processor unit. The calculation unit is capable of calculating at least a characteristic of the hand drawing. The comparison unit electrically connects the calculation unit to compare the characteristic with a plurality of regular characteristics to select an approximation regular characteristic, which is the most approximate to the characteristic among all of the regular characteristics. The processor unit electrically connects the comparison unit. The processor unit is for creating a regular shape based on the approximation regular characteristic and for replacing the hand drawing with the regular shape.

In the foregoing, the user just needs to draw a hand drawing freely. The computer graphic module may verify the hand drawing and transform it into some regular shape. It's easier and more convenient for the user to use when drafting pictures on the computer.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flowchart of a method for computer graphics according to one embodiment of this invention;

FIG. 2A is a broken line graph representing the relationship between the horizontal position and the time each pixel of the hand drawing is made wherein the hand drawing is similar to a rectangle;

FIG. 2B is a broken line graph representing the relationship between the vertical position and the time of each pixel of the hand drawing is made according to FIG. 2A; and

FIG. 3 is a block diagram of a computer graphic module according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

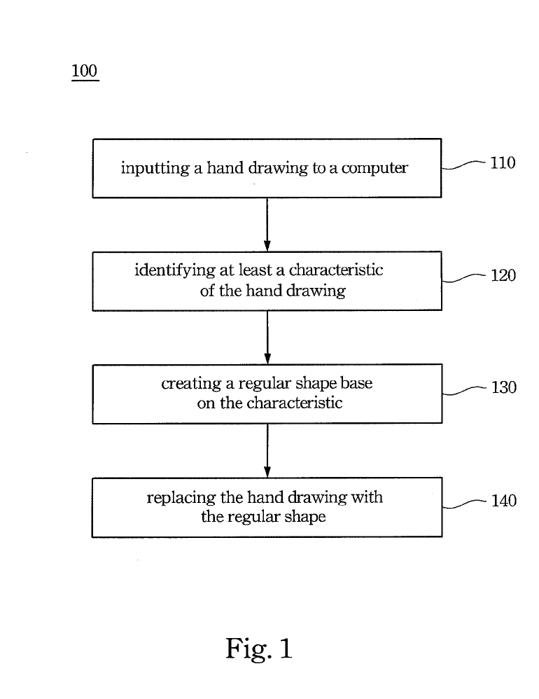

Please refer to FIG. 1. FIG. 1 is a flowchart of a method 100 for computer graphics according to one embodiment of this invention. The first step 110 of the computer graphic method 100 is to input a hand drawing into a computer. In the next step 120 the computer identifies at least one characteristic of the hand drawing. In step 130 the computer generates a regular shape based on the characteristics determined in step 120. Finally, in step 140 the hand drawing is replaced with the regular shape. Each step will be described in detail as follows.

In step 110, a user may input the hand drawing to the computer using an input device to draw freely on the computer. More specifically, the user may operate an input device, like a computer mouse, an electronic whiteboard, or a touch panel, to record a moving track of the input device and to transmit a signal of the moving track to the computer. Take a computer mouse as an example, the user may push a button, like the left button on the mouse to send a start signal to the computer and make the computer start recoding the moving track of the input device. The computer won't stop recording the moving track until the user releases the button. As soon as the user releases the button, the computer may convert the signal of the moving track into a plurality of pixels, which will be shown on the computer monitor. The computer then may link the pixels to form the hand drawing.

In step 120, the computer will identify at least one characteristic of the hand drawing. Those skilled in this art know that each regular shape has some characteristics. Take a rectangle for example, the rectangle has four right angles, two pairs of parallel opposite sides, and the distance between two adjoin ends equal to the differential of the coordinates thereof. Furthermore, when drawing the rectangle, the stroke order must be a horizontal line, a vertical line, a horizontal line, and a vertical line, or reverse. It means that either the horizontal coordinate or the vertical coordinate would be changed at one time, and no oblique lines will occur. Other regular shapes, like circles, ellipses, polygons, straight lines, and curves also have their own characteristics.

In the embodiment of this invention, the characteristic of the hand drawing is a position function representing a relation about where and when the pixels of the hand drawing are formed. More specifically, the position function represents the relationship between a position, like a coordinate and time of each pixel, which may show the stroke order of the hand drawing. Therefore, step 120 includes calculating the relationship between the position and time of each pixel to form the position function.

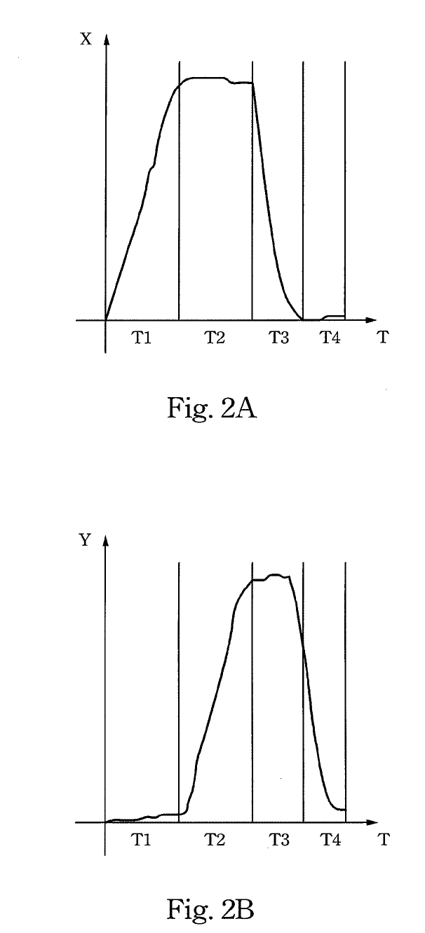

Please refer to FIG. 2A and FIG. 2B. FIG. 2A is a broken line graph representing the relationship between the horizontal position and the time each pixel of the hand drawing is made, and FIG. 2B is a broken line graph of the vertical position and the time each pixel of the hand drawing is made, wherein the hand drawing is similar to a rectangle. As the above, the stroke order of the rectangle must be a horizontal and a vertical line in turn. Therefore, in both the first time period T1 and the third time period T3, the horizontal coordinates vary dramatically and the vertical coordinates stay almost the same. It means that the user was drawing horizontal lines during those time periods. On the other hand, the user was drawing vertical lines during the second time periods T2 and the fourth time periods T4.

In addition, the curve of the hand drawing may be discontinuous or irregular because the user's hand may shake. The computer graphic method further includes a step to optimize the position function to eliminate the error. The way for optimizing the position function may be a linear optimization.

Please refer back to FIG. 1. In step 130, the computer creates the regular shape based on the characteristics. In the embodiment, the characteristic of the hand drawing may be compared to all regular characteristics stored in a database. Every regular characteristic represents different regular shapes. Then, an approximation of the regular characteristics, which is most approximate to the characteristic of the hand drawing, will be selected from the regular characteristics. As the above, the characteristic of the hand drawing is the position function. The regular characteristic is a regular shape equation for generating the regular shape. After comparison, the regular shape will be formed according to the compared result, which should be the approximation regular shape equation.

In another embodiment of this invention, the computer graphic method may use the position function to create the regular shape. More specifically, the computer graphic method uses the optimized position function to produce a plurality of regular points. And then, form the regular shape by linking the regular points.

In the final step 140, the hand drawing will be replaced with the regular shape. In the embodiment of this invention, the regular shape includes a circuit, an ellipse, a rectangle, a polygon, a straight line, or a curve.

In the foregoing, the user just needs to draw a hand drawing similar to a regular shape. The hand drawing may then be transformed into the regular shape. It's easier and more convenient for the user to use when drafting pictures on the computer.

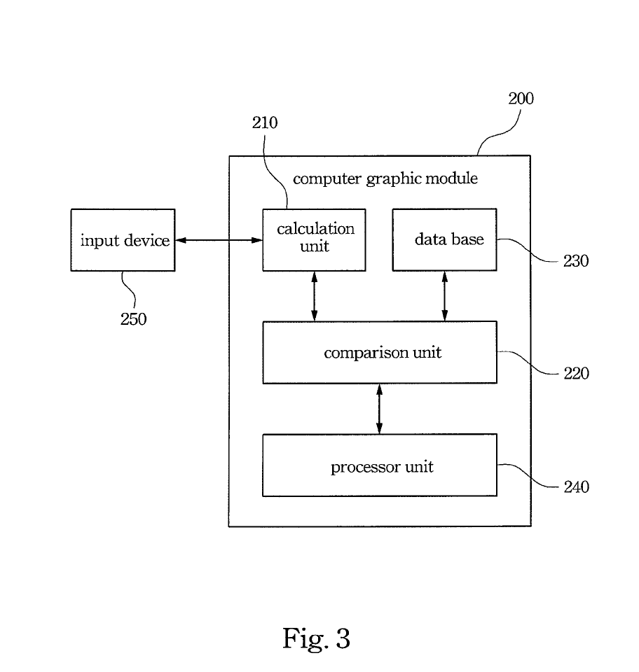

Please refer to FIG. 3. FIG. 3 is a block diagram of a computer graphic module 200 according to another embodiment of this invention. The computer graphic module 200 is capable of producing a regular shape according to an irregular geometric drawing drawn by a user.

When the user draws a hand drawing on a computer with an input device 250, like a computer mouse. The input device 250 transmits a plurality of pixels in sequence to the computer. The computer may link every pixel sequentially to form the hand drawing. The input device 250 may be a computer mouse, an electronic whiteboard, or a touch panel.

A calculation unit 210 of the computer graphic module 200 calculates at least one characteristic of the hand drawing. In the embodiment of this invention, the calculation unit 210 electrically connects the input device 250 to receive the information at every pixel, like the position and the input time of the pixel. The calculation unit 210 may calculate the relation of the position and the input time of every pixel to form a position function. The position function is the characteristic of the hand drawing.

Next, a comparison unit 220 of the computer graphic module 200 will compare the characteristic with a plurality of regular characteristics. The comparison unit 220 electrically connects the calculation unit 210 and a database 230, which stores regular characteristics. The comparison unit 220 may compare the characteristics of the hand drawing with all the regular characteristics in the database 230 to find out one approximate regular characteristic, which is most approximate to the characteristic of the hand drawing among all the regular characteristics. As the above, the characteristic of the hand drawing is the position function. The regular characteristic is a regular shape equation, which could be used to form a regular shape.

A processor unit 240 of the computer graphic module 200 electrically connects the comparison unit 220 and the database 230. The processor unit 240 uses the approximation regular characteristic to create the regular shape. After the regular shape is created, the processor unit 240 will use the regular shape to replace the hand drawing of the user. In the foregoing, the computer graphic method 200 may spontaneously transform the irregular geometric drawing into the regular shape that the user wants. It's convenient for the user to draw many different regular shapes in one picture without selecting a panty of computer graphic tools.

Although the present invention has been described in considerable detail with reference certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of computer graphics, comprising:
inputting a hand drawing to a computer;
identifying at least one characteristic of the hand drawing;
creating a regular shape based on the characteristic; and
replacing the hand drawing with the regular shape.

2. The computer graphic method of claim 1, wherein the step of inputting the hand drawing comprises:
using an input device for transmitting the computer a signal of a moving track of the input device;
converting the signal of the moving track into a plurality of pixels; and
linking the pixels for forming the hand drawing.

3. The computer graphic method of claim 2, wherein the step of identifying the characteristic of the hand drawing comprises:
forming a position function by calculating a relationship between a position and time of each pixel, wherein the position function is the characteristic of the hand drawing.

4. The computer graphic method of claim 3, wherein the step of creating the regular shape base on the characteristic comprises:
comparing the position function with a plurality of regular shape equations;
selecting an approximate regular shape equation from the regular shape equations; and
using the approximation regular shape equation to form the regular shape.

5. The computer graphic method of claim 3, wherein the step of identifying the characteristic of the hand drawing comprises optimizing the position function.

6. The computer graphic method of claim 5, wherein the step of creating the regular shape base on the characteristic comprises:
comparing the position function with a plurality of regular shape equations;
selecting an approximation regular shape equation approximating the position function from the regular shape equations; and
using the approximation regular shape equation to form the regular shape.

7. The computer graphic method of claim 5, wherein the step of creating the regular shape base on the characteristic comprises:
using the optimized position function to produce a plurality of regular points; and
linking the regular points to form the regular shape.

8. The computer graphic method of claim 2, wherein the input device is a computer mouse, an electronic whiteboard, or a touch panel.

9. The computer graphic method of claim 8, wherein the step of using the input device for transmitting the signal of the moving track to the computer comprises:
pushing a button on the input device to start recoding the moving track; and
releasing the button to stop recording.

10. The computer graphic method of claim 1, wherein the regular shape is a circuit, an ellipse, a rectangle, a polygon, a straight line, or a curve.

11. A method of computer graphics, comprising:
drawing a hand drawing in a computer using an input device;
identifying at least a characteristic of the hand drawing;
comparing the characteristic with a plurality of regular characteristics;
creating a regular shape based on compared results; and
replacing the hand drawing with the regular shape.

12. The computer graphic method of claim 11, wherein the step of drawing the hand drawing in the computer by using the input device comprises:
transmitting the computer a signal of a moving track of the input device;
converting the signal of the moving track into a plurality of pixels; and
linking the pixels for forming the hand drawing.

13. The computer graphic method of claim 12, wherein the characteristic of the hand drawing is a position function, which represents a relation of a position and time of each pixel.

14. The computer graphic method of claim 13, wherein the step of identifying the characteristic of the hand drawing comprises optimizing the position function.

15. The computer graphic method of claim 11, wherein the regular shape is a circuit, an ellipse, a rectangle, a polygon, a straight line, or a curve.

16. A computer graphics module, comprising:
a calculation unit, capable of calculating at least a characteristic of a hand drawing;
a comparison unit, electrically connecting the calculation unit, and capable of comparing the characteristic with a plurality of regular characteristics for selecting an approximate regular characteristic approximate the characteristic from the regular characteristics; and
a processor unit, electrically connecting the comparison unit, and capable of creating a regular shape base on the approximate regular characteristic and replacing the hand drawing with the regular shape.

17. The computer graphics module of claim 16, further comprising an input device electrically connecting the processor unit and capable of transmitting a plurality of pixels, wherein the hand drawing is composed of the pixels.

18. The computer graphics module of claim 17, wherein the characteristic of the hand drawing is a position function representing a relation of a position and time of each pixel.

19. The computer graphics module of claim 17, wherein the input device is a computer mouse, an electronic whiteboard, or a touch panel.

20. The computer graphics module of claim 16, further comprising a database electrically connecting the comparison unit and capable of storing the regular characteristics.
